(19) United States
(12) Patent Application Publication
(10) Pub. No.: US 2026/0126662 A1
(43) Pub. Date: May 7, 2026

(54) OPTICAL ENCLOSURE

(71) Applicant: Apple Inc., Cupertino, CA (US)

(72) Inventors: Ivan S. MARIC, San Francisco, CA (US); Cole SNIDER, San Jose, CA (US); Kalman S. SOBEL, San Jose, CA (US); Aidan N. ZIMMERMAN, Sunnyvale, CA (US); Phil M. HOBSON, Menlo Park, CA (US)

(21) Appl. No.: 18/685,873

(22) PCT Filed: Aug. 30, 2022
(86) PCT No.: PCT/US2022/042015

§ 371 Date: Feb. 22, 2024

Related U.S. Application Data
(60) Provisional application No. 63/245,651, filed on Sep. 17, 2021.

(51) Int. Cl. G02B 27/01; G02B 27/00

(52) U.S. Cl. CPC G02B 27/0176; G02B 27/0093; G02B 27/0172; G02B 27/0179; G02B 2027/0138; G02B 2027/0154; G02B 2027/0169; G02B 2027/0187

(57) ABSTRACT

A wearable electronic device can include a unibody optical enclosure for supporting a display and facilitating movement thereof for proper optical alignment with the eyes of the user. The optical enclosure can include a barrel with a tapered diameter and a coating formed thereon with a low reflectance to increase a relative contrast ratio of the display. The optical enclosure can further one or more hangers each defining a channel to receive a guide rod. The hangers can each provide an inner surface with a coating that has a low coefficient of friction to facilitate sliding against the guide rod.

### CROSS-REFERENCE TO RELATED APPLICATION

This application claims the benefit of U.S. Provisional Application No. 63/245, 651, entitled “HEAD-MOUNTABLE DEVICES WITH OPTICAL ENCLOSURE,” filed Sep. 17, 2021, the entirety of which is incorporated herein by reference.

### TECHNICAL FIELD

The present description relates generally to head-mountable devices, and, more particularly, to head-mountable devices with optical enclosures.

### BACKGROUND

A head-mountable device can be worn by a user to display visual information within the field of view of the user. The head-mountable device can be used as a virtual reality (VR) system, an augmented reality (AR) system, and/or a mixed reality (MR) system. A user may observe outputs provided by the head-mountable device, such as visual information provided on a display. The display can optionally allow a user to observe an environment outside of the head-mountable device. Other outputs provided by the head-mountable device can include speaker output and/or haptic feedback. A user may further interact with the head-mountable device by providing inputs for processing by one or more components of the head-mountable device. For example, the user can provide tactile inputs, voice commands, and other inputs while the device is mounted to the user's head.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a top view of a head-mountable device, according to some embodiments of the present disclosure.

FIG. 2 illustrates a rear view of the head-mountable device of FIG. 1, according to some embodiments of the present disclosure.

FIG. 3 illustrates a perspective view of an optical assembly of the head-mountable device of FIGS. 1 and 2, according to some embodiments of the present disclosure.

FIG. 4 illustrates a side view of the optical assembly of FIG. 3, according to some embodiments of the present disclosure.

FIG. 5 illustrates a sectional view of the optical assembly of FIGS. 3 and 4, according to some embodiments of the present disclosure.

FIG. 6 illustrates a block diagram of a head-mountable device, in accordance with some embodiments of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Head-mountable devices, such as head-mountable displays, headsets, visors, smartglasses, head-up display, etc., can perform a range of functions that are managed by the components (e.g., sensors, circuitry, and other hardware) included with the wearable device.

Many of the functions performed by a head-mountable device are optimally experienced when the output is tailored to the needs of the user wearing the head-mountable device. In particular, the visual output features of a head-mountable device can be provided in a manner that accommodates a user's vision, including optimal position and/or orientation based on the eyes of the user. For example, a head-mountable device can detect the eyes of the user and adjust the position and/or orientation of one or more displays to accommodate the user's eyes. Such adjustments can be facilitated by an optical enclosure that is controllably moved to carry the display to the desired position and/or orientation. Accordingly, any given user can properly view the visual output features when using the head-mountable device.

An optical enclosure can be provided for supporting the display. Where the optical enclosure is made from multiple parts, the complexity and cost of fabrication can be relatively high. The interconnection between parts can lead to inferior performance as actuation of one part can be inconsistently translated to other parts. Where a greater number of parts are used, the part count, weight, and assembly procedures (e.g., adhering and/or fastening) may be higher. Furthermore, the multiple parts can shift relative to each other over time.

Embodiments of the present disclosure provide a unibody optical enclosure for supporting a display and facilitating movement thereof for proper optical alignment with the eyes of the user. The optical enclosure can include a barrel with a tapered diameter and a coating formed thereon with a low reflectance to increase a relative contrast ratio of the display. The optical enclosure can further one or more hangers each defining a channel to receive a guide rod. The hangers can each provide an inner surface with a coating that has a low coefficient of friction to facilitate sliding against the guide rod. With a unibody construction, the optical enclosure is able to be made with small tolerances. Fabrication of a unibody optical enclosure is more straightforward and less expensive than when using multiple constituent parts. The total number of parts is reduced, thereby simplifying assembly. By eliminating interfaces between constituent parts of an optical enclosure, activity (e.g., forces, biasing, and engagement) at one portion of the button translates directly to other portions thereof. Assembly tolerances and subsequent cosmetic variation of the button to the surrounding surfaces are reduced due to elimination of the button assembly requirement.

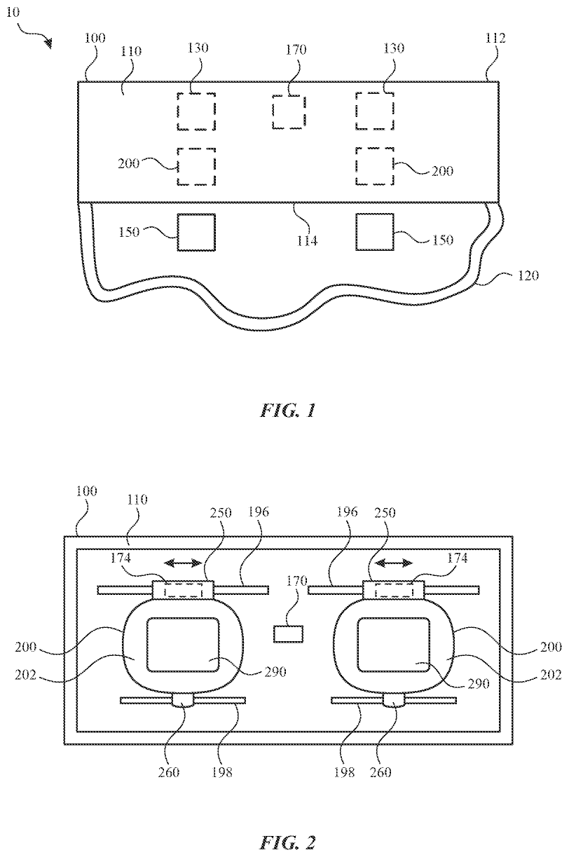

These and other embodiments are discussed below with reference to FIGS. 1-6. However, those skilled in the art will readily appreciate that the detailed description given herein with respect to these Figures is for explanatory purposes only and should not be construed as limiting.

According to some embodiments, for example as shown in FIG. 1, a head-mountable device 10 includes a frame 110 that is worn on a head of a user. The frame 110 can be positioned in front of the eyes of a user to provide information within a field of view of the user. The frame 110 can provide nose pads or another feature to rest on a user's nose and/or engage other parts of the user's face.

The frame 110 can be supported on a user's head with the head engager 120. The head engager 120 can wrap or extend along opposing sides of a user's head. The head engager 120 can optionally include earpieces for wrapping around or otherwise engaging or resting on a user's ears. It will be appreciated that other configurations can be applied for securing the head-mountable device 10 to a user's head. For example, one or more bands, straps, belts, caps, hats, or other components can be used in addition to or in place of the illustrated components of the head-mountable device 10. By further example, the head engager 120 can include multiple components to engage a user's head.

The frame 110 can provide structure around a peripheral region thereof to support any internal components of the head-mountable device 10 in their assembled position. For example, the frame 110 can enclose and support various internal components (including for example integrated circuit chips, processors, memory devices and other circuitry) to provide computing and functional operations for the head-mountable device 10, as discussed further herein. While several components are shown within the frame 110, it will be understood that some or all of these components can be located anywhere within or on the head-mountable device 10. For example, one or more of these components can be positioned within the head engager 120 of the head-mountable device 10.

The frame 110 can include and/or support one or more camera assemblies 130. The camera assemblies 130 can be positioned on or near an outer side 112 of the frame 110 to capture images of views external to the head-mountable device 10. As used herein, an outer side of a portion of a head-mountable device is a side that faces away from the user and/or towards an external environment. The captured images can be used for display to the user or stored for any other purpose. Each of the camera assemblies 130 can be movable along the outer side 112. For example, a track or other guide can be provided for facilitating movement of the camera assembly 130 therein.

The head-mountable device 10 can include optical assemblies 200 that provide visual output for viewing by a user wearing the head-mountable device 10. One or more optical assemblies 200 can be positioned on or near an inner side 114 of the frame 110. As used herein, an inner side 114 of a portion of a head-mountable device is a side that faces toward the user and/or away from the external environment.

An optical assembly 200 can transmit light from a physical environment (e.g., as captured by a camera assembly) for viewing by the user. Such an optical assembly 200 can include optical properties, such as lenses for vision correction based on incoming light from the physical environment. Additionally or alternatively, an optical assembly 200 can provide information with a display 290 within a field of view of the user. Such information can be provided to the exclusion of a view of a physical environment or in addition to (e.g., overlaid with) a physical environment.

A physical environment relates to a physical world that people can sense and/or interact with without necessarily requiring the aid of an electronic device. A computer-generated reality environment relates to a wholly or partially simulated environment that people sense and/or interact with the assistance of an electronic device. Examples of computer-generated reality include mixed reality and virtual reality. Examples of mixed realities can include augmented reality and augmented virtuality. Some examples of electronic devices that enable a person to sense and/or interact with various computer-generated reality environments include head-mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable device can have an integrated opaque display, have a transparent or translucent display, or be configured to accept an external opaque display (e.g., smartphone).

Referring again to FIG. 1, the head-mountable device can include one or more lens assemblies 152. The lens assembly 152 can be or include one or more lenses for providing corrective vision capabilities. It will be understood that, where multiple lenses are used, the lenses of the lens assembly 152 can be provided together or separately (e.g., for combination). One lens assembly 152 can be applied to each of multiple (e.g., two) optical assemblies 200, as described further herein.

Referring now to FIG. 2, the optical assemblies of the head-mountable device can be adjustable to accommodate the facial features of the user wearing the head-mountable device and align each optical assembly with a corresponding eye of the user.

As shown in FIG. 2, each optical assembly 200 can include an optical enclosure 202 and a display 290. The display 290 can be supported by the optical enclosure 202, such that movement (e.g., adjustments to position and/or orientation) of the optical enclosure 202 results and corresponding movement of the display 290.

As further shown in FIG. 2, the head-mountable device 10 can include one or more sensors 170. The sensor 170 can be positioned and arranged to detect a characteristic of the user, such as facial features. For example, such a user sensor can perform facial feature detection, facial movement detection, facial recognition, eye tracking, user mood detection, user emotion detection, voice detection, and the like. While only one sensor 170 is depicted in FIG. 2, it will be understood that any number of sensors 170 can be provided. For example, a sensor 170 can be coupled to, included with, or part of an optical assembly 200. Accordingly, such a sensor 170 can move with the optical assembly 200 and be operated to detect the presence or absence of an eye (e.g., pupil, etc.) of a user, as well as the position and/or orientation thereof with respect to the head-mountable device 10. Such detections can further be used to determine whether the display 290 is in an optimal position and/or orientation with respect to the eye of the user and/or whether adjustments to the optical assembly 200 would be appropriate.

Each optical assembly 200 can be adjusted to align with a corresponding eye of the user. For example, each optical assembly 200 can be moved along and/or about one or more axes until a center of each optical assembly 200 is aligned with a center of the corresponding eye. Accordingly, the distance between the optical assemblies 200 can be set based on an interpupillary distance (“IPD”) of the user. IPD is defined as the distance between the centers of the pupils of a user's eyes. While translational movement is depicted in FIG. 2, it will be further understood that rotational movement can, additionally or alternatively, be facilitated with respect to the frame 110.

The pair of optical assemblies 200 can be mounted to the frame 110 and separated by a distance. The distance between the pair of optical assemblies 200 can be designed to correspond to the IPD of a user. The distance can be adjustable to account for different IPDs of different users that may wear the head-mountable device 10. For example, either or both of the optical assemblies 200 may be movably mounted to the frame 110 to permit the optical assemblies 200 to move or translate laterally to make the distance larger or smaller. Any type of manual or automatic mechanism may be used to permit the distance between the optical assemblies 200 to be an adjustable distance. For example, the optical assemblies 200 can be mounted to the frame 110 via slidable tracks or guides that permit manual or electronically actuated movement of one or more of the optical assemblies 200 to adjust the distance there between. By further example, the optical enclosures 202 can each include one or more hangers that interact with guide rods of the head-mountable device 10 to facilitate movement. By further example, an upper hanger 250 can facilitate movement of the optical assembly 200 by sliding along an upper guide rod 196 coupled to the frame 110, and/or a lower hanger 260 can facilitate movement of the optical assembly 200 by sliding along a lower guide rod 198 coupled to the frame 110. One or more motors 174 can be operated to effect movement of the optical assembly 200 with respect to the frame 110. The motors 174 can operate independently to move each of the optical assemblies 200. Additionally or alternatively, a single motor 174 can be operated to simultaneously move each of the optical assemblies 200, for example with opposite but symmetrical movement.

Additionally or alternatively, the optical assemblies 200 can each be moved to a target location based on a desired visual effect that corresponds to user's perception of the optical assembly 200 when it is positioned at the target location. The target location can be determined based on a focal length of the user and/or optics of the system. For example, the user's eye and/or optics of the system can determine how the visual output of the optical assembly 200 will be perceived by the user. The distance between the optical assembly 200 and the user's eye and/or the distance between the optical assembly 200 and one or more optics can be altered to place the optical assembly 200 at, within, or outside of a corresponding focal distance. Such adjustments can be useful to accommodate a particular user's eye, corrective lenses, and/or a desired optical effect.

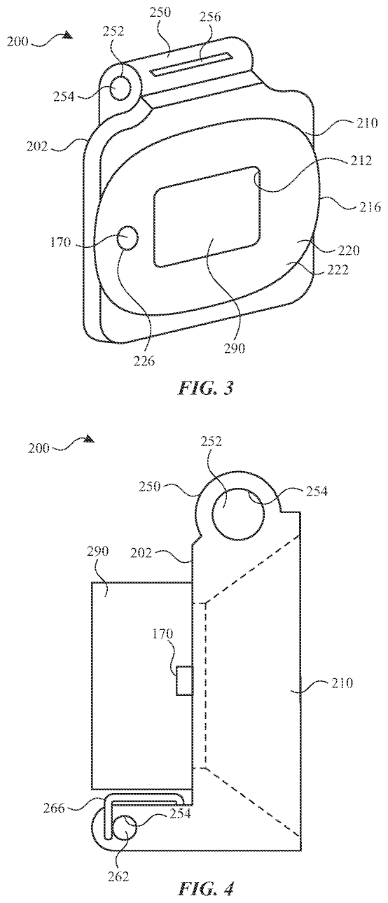

Referring now to FIGS. 3-5, an optical assembly can include a display and an optical enclosure that supports the display, provides a view to the display, and facilitates movement of the display.

FIG. 3 illustrates a perspective view of an optical assembly. As shown in FIG. 3, each optical assembly 200 can include a display 290 within, coupled to, and/or adjacent to an optical enclosure 202. The optical enclosure 202 can surround an outer periphery of the display 290 and/or an output portion thereof and provide support thereto. Additionally, the optical enclosure 202 can define at least a portion of a periphery of the optical assembly 200.

The display 290 of the optical assembly 200 can be operated to display visual information for a user. For example, the display 290 can provide visual (e.g., image or video) output by utilizing, for example, digital light projection, OLEDs, LEDS, uLEDs, liquid crystal on silicon, laser scanning light source, or any combination of these technologies.

The optical enclosure 202 can include a barrel 210 that provides a view to the display 290. For example, the barrel 210 can define a barrel channel 220 that extends from a first barrel end 212 to a second barrel end 216. The first barrel and 212 of the barrel channel 220 can surround an output portion of the display 290, such that a user can view the display 290 by being provided with light output from the display 290 through the barrel channel 220. Additionally, the barrel channel 220 can face at least partly towards the eye of the user, such that, as viewed by the user, the barrel channel 220 is adjacent to the display 290.

The barrel channel 220 can define a surface with a barrel coating 222 formed thereon, formed on a surface of the barrel channel 220. The barrel coating 222 can have a low reflectance to increase a relative contrast ratio of the display 290. For example, the barrel coating 222 can be a paint or other light absorbing substance. The barrel coating 222 can have a reflectance (R) of less than 8%, 7%, 6%, 5%, 4%, 3%, 2%, or 1%, inclusive of any values and/or increments there between. As used herein, reflectance is determined as total hemispherical reflectance for all light, within a given range of wavelengths, that is scattered off at all angles.

In some embodiments, reflectance represents an average percentage of light across the visible spectrum (380 to 700 nm) that is reflected by the coating. By providing a low-reflectance coating, the reflections of light off of the barrel channel 220 (i.e., at the barrel coating 222) are limited, and the relative contrast ratio of the display 290 is enhanced. Accordingly, the user can perceive the output of the display 290 more accurately and with higher fidelity.

In some embodiments, reflectance represents an average percentage of light across another spectrum, such as the near infrared spectrum (760 to 1040 nm) that is reflected by the coating. By providing a low-reflectance coating, the reflections of light off of the barrel channel 220 (i.e., at the barrel coating 222) are limited, and light reflected off of the eye for eye-tracking purposes can be enhanced. Accordingly, eye sensors can more accurately detect and track the eyes of the user with higher fidelity.

The optical enclosure 202 can further include an upper hanger 250. The upper hanger 250 can extend from the barrel 210 of the optical enclosure 202. The upper hanger 250 can include a hanger channel 252 for receiving a guide rod. The upper hanger 250 can facilitate movement of the optical assembly 200 by sliding along a corresponding guide rod and/or other structure. The optical assembly 200 can further include one or more biasing springs 256 that can extend radially inwardly into the hanger channel 252 to engage a guide rod therein. The biasing springs and/or the guide rods can be coated with low friction and/or wear resistant coatings. For example, such a coating can have a static or dynamic coefficient of friction (μ) against the guide rod of less than 0.6, 0.5, 0.4, 0.3, 0.2, or 0.1, inclusive of any values and/or increments there between.

The upper hanger 250 and/or the lower hanger 260 can each define an inner surface with a hanger coating formed thereon. For example, the hanger coating 254 can be a plating. By further example, the hanger coating 254 can be provided by an electroless plating process. The materials for the hanger coating 254 can be, for example, nickel, nickel-phosphorus, nickel-gold, nickel-boron, palladium, and/or copper. For example, the material of the hanger coating 254 can be different than the material of the optical enclosure 202.

The hanger coating 254 can have a have a low coefficient of friction (static or dynamic) to facilitate sliding against a guide rod. Processes such as electroless plating can help achieve an even surface of the hanger coating 254 regardless of the geometry of the hanger channel 252 by not relying on uneven current densities, as in electroplating. The hanger coating 254 can have a static or dynamic coefficient of friction (μ) against the guide rod of less than 0.6, 0.5, 0.4, 0.3, 0.2, or 0.1, inclusive of any values and/or increments there between. These values can represent lubricated or dry conditions.

The optical enclosure 202 can be a unibody structure, rather than an assembly of parts that are assembled together. As used herein, a unibody structure is one that is integrally formed of a single piece. For example, the optical enclosure 202 can be a monolithic structure that includes the barrel 210, the upper hanger 250, and/or the lower hanger 260. By further example, the entirety of the optical enclosure 202 can be of a continuous material and/or materials. By further example, the optical enclosure 202 can lack or omit joining structures between portions thereof, such as adhesives, snaps, locks, latches, fasteners, and the like. By providing a unibody and/or monolithic optical enclosure 202, the optical enclosure 202 does not contain dimensional variations that occur in assembled parts. Accordingly, the unibody optical enclosure 202 can be fabricated to more precise and consistent dimensions. Additionally, the optical enclosure 202 can avoid the added weight that would be imposed by adhesives and/or other securing mechanisms between constituent parts of an assembled optical enclosure.

The optical enclosure 202 can be formed of a single material or mixture (e.g., alloy) of materials. For example, the unibody and/or monolithic optical enclosure 202 can be made from a metallic material (e.g., metal and/or metal alloy). For example, the optical enclosure 202 can be of magnesium, magnesium, yttrium, neodymium, zirconium, aluminum, steel, another metal, and/or alloys thereof. The optical enclosure 202 can be formed by extrusion, forging, machining, and/or combinations thereof. Additionally or alternatively, finishing steps can be performed, such as plating, tumbling, coating, polishing, and the like.

Optionally, coatings can be provided separately from the unibody and/or monolithic optical enclosure 202. For example, while the barrel 210, the upper hanger 250, and/or the lower hanger 260 can be a unibody and/or monolithic structure, the barrel coating 222 can be separately provided to the barrel channel 220. By further example, the hanger coating 254 can be provided to a hanger channel. As such, the coatings can be considered as not forming part of the unibody and/or monolithic structure of the optical enclosure 202.

The barrel 210 can further form a sensor channel 226 to allow a sensor 170 to track the user (e.g., the user's eye) while the user is wearing the head-mountable device. Accordingly, the sensor 170, being coupled to the optical enclosure 202, can move with the optical assembly 200 and detect characteristics of the user's eye.

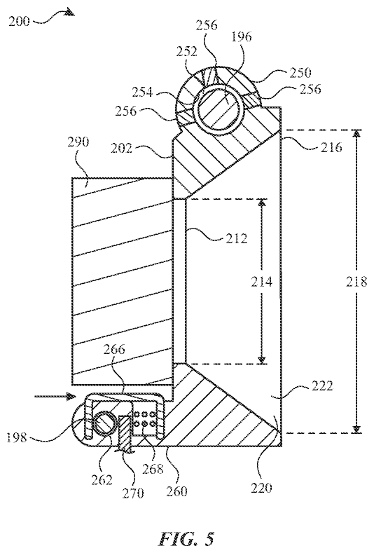

FIG. 4 illustrates a side view of the optical assembly of FIG. 3. As shown in FIG. 4, the optical enclosure 202 can further include as lower hanger 260 at a side of the barrel 210 that is opposite the upper hanger 250. The lower hanger 260 can extend from the barrel 210 of the optical enclosure 202. The lower hanger 260 can include a hanger channel 262 for receiving a guide rod. The lower hanger 260 can facilitate movement of the optical assembly 200 by sliding along a corresponding guide rod and/or other structure. The optical assembly 200 can further include one or more biasing arms 266 that can extend into or alongside the hanger channel 262 to engage a guide rod therein. By providing a pair of hanger channels, movement of the optical assembly 200 can be limited to, for example, one axis of motion. It will be understood that additional configurations can provide a greater number and/or different degrees of freedom.

FIG. 5 illustrates a sectional view of the optical assembly of FIGS. 3 and 4, according to some embodiments of the present disclosure.

As shown in FIG. 5, the barrel 210 can define the barrel channel 220 extending from a first barrel end 212 with a first barrel diameter 214 to a second barrel end 216 with a second barrel diameter 218 that is larger than the first barrel diameter 214. For example, the barrel channel 220 can generally form a conical and/or frustoconical shape that tapers from one end to another. As such, the first barrel end 212 can couple to the display 290 such that the barrel channel 220 provides a view of the display 290 for a user positioned at or near the second barrel end 216. While the cross-sectional shape can be generally circular (e.g., defining a diameter), it will be understood that such terms can include other shapes that transition from the smaller first barrel end 212 to the larger second barrel end 216. The surface defined by the barrel channel 220 and/or the barrel coating 222 formed thereon can face the user, such that light is largely absorbed by the barrel coating 222 in a portion of the user's view that is adjacent to a perimeter of the display 290 and/or the user's view thereof.

As further shown in FIG. 5, the optical assembly 200 can further include one or more biasing springs 256 that can extend radially inwardly into the upper hanger channel 252 to engage the upper guide rod 196 therein. The biasing springs 256 can bias the upper guide rod 196 to abut the hanger coating 254 provided on the inner surface of the upper hanger channel 252. This can reduce an amount of play that would otherwise arise based on the provision of an upper guide rod 196 that is somewhat smaller than the upper hanger channel 252 through which it extends.

As further shown in FIG. 5, The optical assembly 200 can further include one or more biasing arms 266 that can extend into or alongside the lower hanger channel 262 to engage the lower guide rod 198 therein. The biasing arms 266 can be biased by a biasing spring 268 within the optical enclosure 202. The action provided by such biasing can cause the lower guide rod 198 to be pressed up against a datum pin 270 throughout a range of motion of the optical assembly 200 along the lower guide rod 198. This can reduce an amount of play that would otherwise arise based on the provision of a lower guide rod 198 that is somewhat smaller than the lower hanger channel 262 through which it extends.

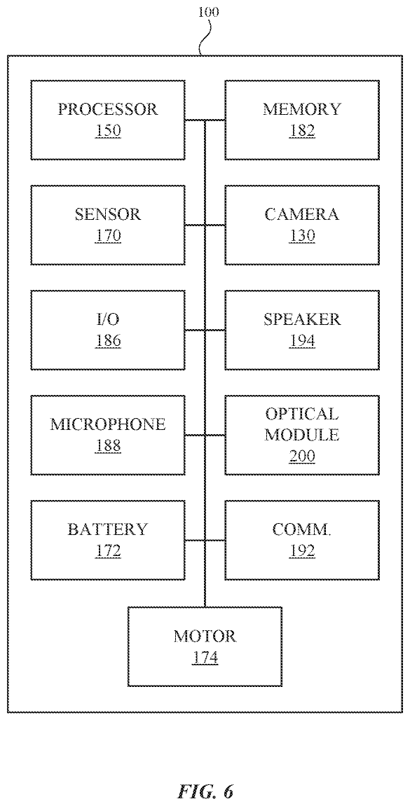

Referring now to FIG. 6, components of the head-mountable device can be operably connected to provide the performance described herein. FIG. 6 shows a simplified block diagram of an illustrative head-mountable device 10 in accordance with one embodiment of the invention. It will be understood that additional components, different components, or fewer components than those illustrated may be utilized within the scope of the subject disclosure.

As shown in FIG. 6, the head-mountable device 10 can include a processor 150 (e.g., control circuity) with one or more processing units that include or are configured to access a memory 182 having instructions stored thereon. The instructions or computer programs may be configured to perform one or more of the operations or functions described with respect to the head-mountable device 10. The processor 150 can be implemented as any electronic device capable of processing, receiving, or transmitting data or instructions. For example, the processor 150 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements. The processor can be a component of and/or operably connected to the control board and/or another component of the head-mountable device.

The memory 182 can store electronic data that can be used by the head-mountable device 10. For example, the memory 182 can store electrical data or content such as, for example, audio and video files, documents and applications, device settings and user preferences, timing and control signals or data for the various assemblies, data structures or databases, and so on. The memory 182 can be configured as any type of memory. By way of example only, the memory 182 can be implemented as random access memory, read-only memory, Flash memory, removable memory, or other types of storage elements, or combinations of such devices.

The head-mountable device 10 can include adjustment control components described herein, such as a motor 174, an actuator, and the like for moving components (e.g., optical assemblies 200) to a desired relative position and/or orientation.

The head-mountable device 10 can include one or more sensors 170, such as the sensors of a sensor assembly, as described herein.

The head-mountable device 10 can include an input/output component 186, which can include any suitable component for connecting head-mountable device 10 to other devices. Suitable components can include, for example, audio/video jacks, data connectors, or any additional or alternative input/output components. The input/output component 186 can include buttons, keys, or another feature that can act as a keyboard for operation by the user.

The head-mountable device 10 can include the microphone 188 as described herein. The microphone 188 can be operably connected to the processor 150 for detection of sound levels and communication of detections for further processing, as described further herein.

The head-mountable device 10 can include the speakers 194 as described herein. The speakers 190 can be operably connected to the processor 150 for control of speaker output, including sound levels, as described further herein.

The head-mountable device 10 can include communications circuitry 192 for communicating with one or more servers or other devices using any suitable communications protocol. For example, communications circuitry 192 can support Wi-Fi (e.g., a 802.11 protocol), Ethernet, Bluetooth, high frequency systems (e.g., 900 MHz, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. Communications circuitry 192 can also include an antenna for transmitting and receiving electromagnetic signals.

The head-mountable device 10 can include a battery 172, which can charge and/or power components of the head-mountable device 10. The battery 172 can also charge and/or power components connected to the head-mountable device 10 (e.g., the lens assembly 152).

Accordingly, embodiments of the present disclosure provide a unibody optical enclosure for supporting a display and facilitating movement thereof for proper optical alignment with the eyes of the user. The optical enclosure can include a barrel with a tapered diameter and a coating formed thereon with a low reflectance to increase a relative contrast ratio of the display. The optical enclosure can further one or more hangers each defining a channel to receive a guide rod. The hangers can each provide an inner surface with a coating that has a low coefficient of friction to facilitate sliding against the guide rod. With a unibody construction, the optical enclosure is able to be made with small tolerances. Fabrication of a unibody optical enclosure is more straightforward and less expensive than when using multiple constituent parts. The total number of parts is reduced, thereby simplifying assembly. By eliminating interfaces between constituent parts of an optical enclosure, activity (e.g., forces, biasing, and engagement) at one portion of the button translates directly to other portions thereof. Assembly tolerances and subsequent cosmetic variation of the button to the surrounding surfaces are reduced due to elimination of the button assembly requirement.

Various examples of aspects of the disclosure are described below as clauses for convenience. These are provided as examples, and do not limit the subject technology.

Clause A: an optical enclosure for a head-mountable device, the optical enclosure comprising: a barrel defining a barrel channel extending from a first barrel end with a first barrel diameter to a second barrel end with a second barrel diameter that is larger than the first barrel diameter, the first barrel end being configured to couple to a display such that the barrel channel provides a view of the display; a barrel coating formed on a surface of the barrel channel such that the barrel coating is adjacent to a perimeter of the display; a hanger extending from the barrel, the hanger defining a hanger channel, wherein the hanger channel is configured to receive a guide rod and permit the optical enclosure to move within the head-mountable device, wherein the barrel and the upper hanger are made from a metallic material; and a hanger coating formed on a surface of the hanger channel.

Clause B: an optical enclosure for a head-mountable device, the optical enclosure comprising: a barrel defining a barrel channel, wherein the barrel is configured to couple to a display and to permit a user to view the display through the barrel channel; a barrel coating formed on the barrel channel and having a reflectance of less than 4% to increase a relative contrast ratio of the display; and a hanger extending from the barrel, wherein the hanger is configured to receive a guide rod and permit the optical enclosure to move within the head-mountable device.

Clause C: an optical enclosure for a head-mountable device, the optical enclosure comprising: a barrel configured to couple to a display and provide a view to the display; a hanger extending from the barrel, the hanger defining a hanger channel having a hanger surface; and a hanger coating formed on the hanger surface and having a coefficient of friction of less than 0.4, wherein the hanger channel is configured to receive a guide rod and the hanger coating is configured to slide against the guide rod to permit the optical enclosure to move within the head-mountable device.

One or more of the above clauses can include one or more of the features described below. It is noted that any of the following clauses may be combined in any combination with each other, and placed into a respective independent clause, e.g., clause A, B, or C.

Clause 1: the barrel and the hanger form a monolithic structure.

Clause 2: the barrel coating has a reflectance of less than 4% to increase a relative contrast ratio of the display.

Clause 3: the hanger coating has a coefficient of friction of less than 0.4.

Clause 4: the hanger is an upper hanger; the guide rod is an upper guide rod; and the optical enclosure further comprises a lower hanger extending from the barrel on a side of the barrel that is opposite the upper hanger, the lower hanger configured to receive a lower guide rod.

Clause 5: the optical enclosure is configured to receive a lens assembly such that the view of the display is provided through a lens of the lens assembly.

Clause 6: a frame supporting the guide rod.

Clause 7: a sensor configured to detect a location of an eye of a user with respect to the display; and a motor operable to move the optical enclosure with respect to the frame based on the detected location of the eye.

Clause 8: a camera supported by the frame; a microphone supported by the frame; a speaker supported by the frame; and a head engager configured to secure the frame to a head of a user.

Clause 9: the barrel channel extends from a first barrel end with a first barrel diameter to a second barrel end with a second barrel diameter that is larger than the first barrel diameter.

Clause 10: a sensor, wherein the barrel forms an opening extending to the barrel channel to provide the sensor with a view of the user wearing the head-mountable device.

Clause 11: a biasing spring configured to engage the guide rod and bias the guide rod against the hanger coating.

Clause 12: the hanger is an upper hanger; the guide rod is an upper guide rod; and the optical enclosure further comprises a lower hanger extending from the barrel on a side of the barrel that is opposite the upper hanger, the lower hanger configured to receive a lower guide rod.

Clause 13: a frame supporting the guide rod; a sensor configured to detect a location of an eye of a user with respect to the display; and a motor operable to move the optical enclosure with respect to the frame based on the detected location of the eye.

As described above, one aspect of the present technology may include the gathering and use of data. The present disclosure contemplates that in some instances, this gathered data may include personal information or other data that uniquely identifies or can be used to locate or contact a specific person. The present disclosure contemplates that the entities responsible for the collection, disclosure, analysis, storage, transfer, or other use of such personal information or other data will comply with well-established privacy policies and/or privacy practices. The present disclosure also contemplates embodiments in which users can selectively block the use of or access to personal information or other data (e.g., managed to minimize risks of unintentional or unauthorized access or use).

A reference to an element in the singular is not intended to mean one and only one unless specifically so stated, but rather one or more. For example, “a” assembly may refer to one or more assemblies. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. An optical enclosure for a head-mountable device, the optical enclosure comprising:
a barrel defining a barrel channel extending from a first barrel end with a first barrel diameter to a second barrel end with a second barrel diameter that is larger than the first barrel diameter, the first barrel end being configured to couple to a display such that the barrel channel provides a view of the display;
a barrel coating formed on a surface of the barrel channel such that the barrel coating is adjacent to a perimeter of the display;
a hanger extending from the barrel, the hanger defining a hanger channel, wherein the hanger channel is configured to receive a guide rod and permit the optical enclosure to move within the head-mountable device, wherein the barrel and the upper hanger are made from a metallic material; and
a hanger coating formed on a surface of the hanger channel.

2. The optical enclosure of claim 1, wherein the barrel and the hanger form a monolithic structure.

3. The optical enclosure of claim 1, wherein the barrel coating has a total hemispherical reflectance of less than 4% in the visible spectrum and less than 5% in the near infrared spectrum.

4. The optical enclosure of claim 1, wherein the hanger coating has a static coefficient of friction of less than 0.4.

5. The optical enclosure of claim 1, wherein:
the hanger is an upper hanger;
the guide rod is an upper guide rod; and
the optical enclosure further comprises a lower hanger extending from the barrel on a side of the barrel that is opposite the upper hanger, the lower hanger configured to receive a lower guide rod.

6. The head-mountable device of claim 1, wherein the optical enclosure is configured to receive a lens assembly such that the display is viewable through a lens of the lens assembly.

7. A head-mountable device comprising:
the optical enclosure of claim 1;
the display coupled to the optical enclosure; and
a frame supporting the guide rod.

8. The head-mountable device of claim 7, further comprising
a sensor configured to detect a location of an eye with respect to the display; and
a motor operable to move the optical enclosure with respect to the frame based on the detected location of the eye.

9. The head-mountable device of claim 7, further comprising:
a camera supported by the frame;
a microphone supported by the frame;
a speaker supported by the frame; and
a head engager configured to secure the frame to a head.

10. An optical enclosure for a head-mountable device, the optical enclosure comprising:
a barrel defining a barrel channel, wherein the barrel is configured to couple to a display and to provide a view the display through the barrel channel; and
a barrel coating formed on the barrel channel and having a total hemispherical reflectance of less than 4% in the visible spectrum and less than 5% in the near infrared spectrum; and
a hanger extending from the barrel, wherein the hanger is configured to receive a guide rod and permit the optical enclosure to move within the head-mountable device.

11. The optical enclosure of claim 10, wherein the barrel channel extends from a first barrel end with a first barrel diameter to a second barrel end with a second barrel diameter that is larger than the first barrel diameter.

12. The optical enclosure of claim 10, wherein the barrel and the hanger form a monolithic structure.

13. The optical enclosure of claim 10, further comprising a sensor, wherein the barrel forms a sensor channel extending to the barrel channel to allow the sensor to track an eye.

14. The optical enclosure of claim 10, wherein:
the hanger is an upper hanger;
the guide rod is an upper guide rod; and
the optical enclosure further comprises a lower hanger extending from the barrel on a side of the barrel that is opposite the upper hanger, the lower hanger configured to receive a lower guide rod.

15. A head-mountable device comprising:
the optical enclosure of claim 10;
the display coupled to the optical enclosure;
a frame supporting the guide rod;
a sensor configured to detect a location of an eye with respect to the display; and
a motor operable to move the optical enclosure with respect to the frame based on the detected location of the eye.

16. An optical enclosure for a head-mountable device, the optical enclosure comprising:
a barrel configured to couple to a display;
a hanger extending from the barrel, the hanger defining a hanger channel having a hanger surface; and
a hanger coating formed on the hanger surface and having a static coefficient of friction of less than 0.4, wherein the hanger channel is configured to receive a guide rod and the hanger coating is configured to slide against the guide rod to permit the optical enclosure to move within the head-mountable device.

17. The optical enclosure of claim 16, further comprising a biasing spring configured to engage the guide rod and bias the guide rod against the hanger coating.

18. The optical enclosure of claim 16, wherein the barrel and the hanger form a monolithic structure.

19. The optical enclosure of claim 16, wherein:
the hanger is an upper hanger;
the guide rod is an upper guide rod; and
the optical enclosure further comprises a lower hanger extending from the barrel on a side of the barrel that is opposite the upper hanger, the lower hanger configured to receive a lower guide rod.

20. A head-mountable device comprising:
the optical enclosure of claim 16;
the display coupled to the optical enclosure;
a frame supporting the guide rod;
a sensor configured to detect a location of an eye with respect to the display; and
a motor operable to move the optical enclosure with respect to the frame based on the detected location of the eye.
